(19) United States
(12) Patent Application Publication
(10) Pub. No.: US 2001/0033659 A1
(43) Pub. Date: Oct. 25, 2001

(54) System and method for granting electronic rights using the signature of distributable physical media

(76) Inventor: Scott Eisenberg, Bethesda, MD (US)

Correspondence Address: Roberts Abokhair & Mardula, LLC, Suite 1000, 11800 Sunrise Drive, Reston, VA, 20191-5302, US

(21) Appl. No.: 09/759,720

(22) Filed: Jan. 12, 2001

Related U.S. Application Data
(60) Provisional application No. 60/175,966, filed on Jan. 13, 2000.

(51) Int. Cl. H04N 7/167; G06F 17/60; H04L 9/00

(52) U.S. Cl. 380/203; 705/57

(57) ABSTRACT

A system and method for determining the media signature on a physical media to grant electronic rights, which includes a media signature detector for detecting and reading a media signature on a physical media and a media signature judging unit for determining a specific title of an entertainment form.

### CROSS REFERENCE TO RELATED APPLICATIONS

This application claims priority under 35 U.S.C. § 119(e) from provisional application No. 60/175,966, filed Jan. 13, 1999. The No. 60/175,966 provisional application is incorporated by reference herein, in its entirety, for all purposes.

### BACKGROUND OF THE INVENTION

The present invention relates generally to the field of digital communications. More particularly, the present invention relates to the use of a physical media signature to establish media rights and allow replication and other derivative services (including streaming of content to a customer) concerning a physical media by a service provider on behalf of an owner of the physical media.

Conventional physical entertainment media distributed through physical channels (e.g., retail outlets) has some form of encoded identification (e.g., signature), either explicit or implicit from the structure and form of the content that can be used to determine its SKU. In some products, the media also has data that describes the media contents.

The purchase of a physical media (e.g., a compact disk, DVD, DAT tape) grants the purchaser under copyright law certain limited rights to create electronic copies for their personal use. Other copying privileges may exist due to provisions of private contracts between the copyright owner and others. These electronic copies can be made and stored on any variety of devices including analog audio tape, recordable CDs, DAT tape, videotape, a local storage device, and a remote storage device on a network (“network” meaning anything from a small LAN to a global interconnected network of networks, such as the Internet).

Typically, with conventional approaches, the user has to copy or convert the entertainment media from physical format into a digital electronic format on their own through any of a variety of means. Some examples of ways to do this are: buying an extra record/play device, borrowing a friend's record/play device, purchasing multiple copies of the same music in different formats, or buying a computer and software capable of recording a CD and the like. In some cases the physical media may already be in a digital electronic format and the user is simply copying.

Such conventional methods are expensive, time-consuming and inconvenient.

What is needed is a convenient way to provide a consumer who has purchased a recorded work with a copy of that work in a digital electronic format.

### SUMMARY OF THE INVENTION

It is, therefore, an object of the present invention to provide a structure and method that uses the signature of the media on which the work is recorded to establish media rights and allow additional, outside parties to create and provide the digital copies of the media according to the rights granted by the purchase of the physical media, as well as other copying privileges that may exist according to private contract.

One aspect of the present invention is a system that uses the media signature encoded on a physical media to grant electronic rights. This system includes a media signature detector for determining, detecting, and reading a media signature on a physical media and a media signature judging unit for determining a specific title of an entertainment form. The media signature detector according to the present invention computes a signature that is statistically unique (i.e., having a vanishingly small chance of confusion) from a physical CD, digital audio tape, DVD, or HDCD.

The invention provides a given user with access only to media that that user has purchased (and therefore has rights to copy for personal use). The user's access to the service is protected by an authentication of identity and the website performs a fraud watch function automatically to ensure that only an authorized user copies the media which they have rights to copy. Authentication of identity is implemented using any effective technique, including (but not limited to) biometric comparison, a smart card, or even a simple password protocol.

With the present invention, the user is afforded many advantages including rapid and convenient replication. There are safeguards and safety feature to provide privacy and security to the user and protect the interests of copyright holders. For example, the invention uses a website with a database only accessible to authorized users.

Additionally, the invention offers special features that enhance the user's enjoyment of the music on the CD. For instance, different formatting options can be programmed for allowing songs to be linked together or combined to suit a user's need. Also, the music can be reformatted periodically as popular user formats and capabilities change. A further special feature enables blockage so that overplaying (e.g., too many “plays” of a recorded piece of music, etc.) does not occur.

### BRIEF DESCRIPTION OF THE DRAWINGS

Additional objects and advantages of the present invention will be apparent in the following detailed description read in conjunction with the accompanying drawing figures.

FIG. 1 illustrates a flow diagram illustrating methods for practicing the invention.

FIG. 2 illustrates a block diagram of a system according to an embodiment of the present invention.

FIG. 3 illustrates a block diagram of a system according to another embodiment of the present invention.

### DETAILED DESCRIPTION

According to the signature detection aspect of the present invention, a signature is computed from a physical media item (e.g., CD, digital audio tape, DVD, or HDCD) that is reasonably unique. The signature is provided by a purchaser of the media to a service provider. The service provider then provides a digital copy of the CD to the original purchaser in a variety of formats. The service provider is not limited to how it obtains the digital copy to be provided but typically a single physical copy purchased by the service provider is held in a database and used for any number of approved purchasers. Alternatively, it is by accessing the original physical media of the purchaser (e.g., via an upload from the purchaser's PC).

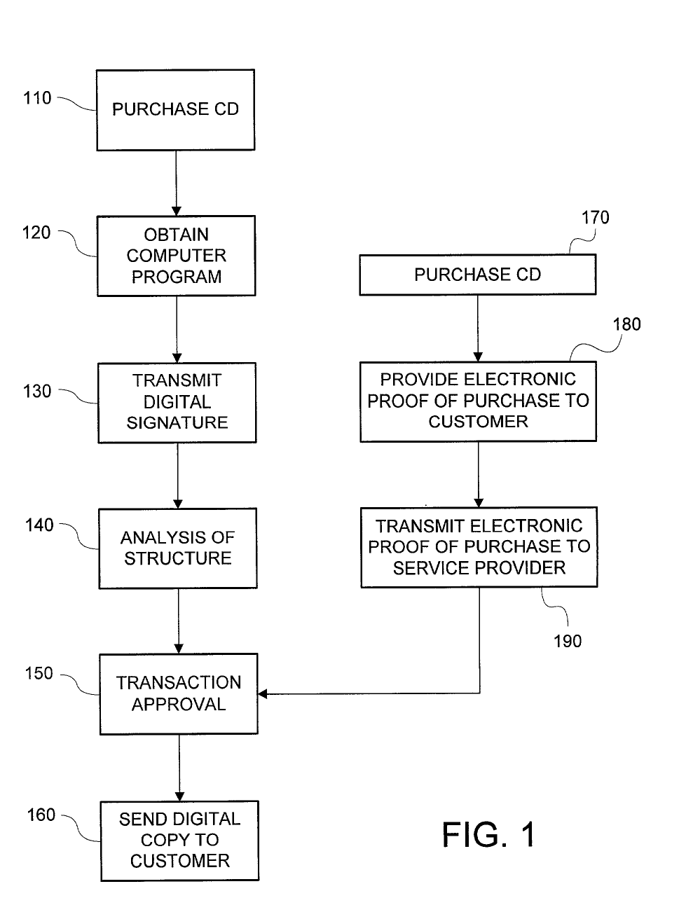

Referring to FIG. 1, a flow diagram illustrating methods for practicing the invention is illustrated. This unique method establishes media rights and allows the purchaser/owner of the media legitimate replication ability. First, a customer (or “user”) purchases 110 a physical media, such as a compact disc, from a vendor (e.g., retail store, mail club). Next, the customer obtains 120 from a service provider (via traditional means, over the Internet, etc.) a computer program for determining the digital signature of the CD.

The computer program is alternately embodied as a local application, a JAVA application, an OCX, or any other program that can physically access the media. The program reads the media to determine its primary type (such as an audio CD, DVD, and CD-ROM) and then uses the specific format of the primary type to read pertinent data. According to a preferred mode of operation, for a standard audio CD, the pertinent data is the number of tracks on the CD and the length of each track. For details of implementation of such an algorithm, refer to U.S. Pat. No. 6,061,680 to Scherf et al. Alternatively, for more advanced audio CDs, this would be the extended track data, including the name of the artist, the name of the album and the name of the individual tacks. This pertinent data is then used to calculate the media signature. In the case of an audio CD, this is effectively done using a simple hash (e.g., MD5 or SHA) of the number of tracks and the track lengths in a specified format.

The scope of the present invention is not limited to calculating the signature as described above, but is effectively practiced using more straightforward techniques. A suitable alternative is for the signature reader to directly read a signature in a physical media that contains an explicit SKU and/or a Ser. No. (e.g., the 2,334,227^{th} copy of a particular CD) to read.

Another alternative embodiment is to generate a signature for the physical media that is statistically unique (i.e., having a vanishingly small chance of confusion) based on manufacturing errors present on the physical media. This error signature is computing from the physical media item and is as unique as a fingerprint. All CDs (as well as other similar digital recording techniques) contain a plethora of random bit errors that are an unavoidable result of the manufacturing process. It is statistically impossible that any two CDs will have the exact same random bit errors over the literally billions of bits that are recorded on those items. Of course, these errors are rarely evident to the user because the recorded bits are encoded using error correction coding (typically according to a Reed-Solomon cross-interleaved code) that is very forgiving of these manufacturing errors, and is capable of faithfully reproducing the recorded work from all but the most egregiously mis-manufactured CDs. A signature generated according to this alternate embodiment exploits these errors (rather than correcting and hiding them) for their inherent statistical uniqueness.

Another alternative embodiment is to generate a signature for the physical media that is statistically unique based on selected reading of music data at specific locations across the CD. The specific locations are preferably selected relative to each track (e.g., thirty seconds into each track). Optionally, the specific locations are selected based on their absolute location on the CD.

Once a signature is ascertained, the customer transmits 130 to the service provider the digital signature corresponding to the physical media they have purchased. The service provider analyzes 140 the signature to determine which particular CD title the consumer has purchased. Upon approval 150 of the signature, the service provider obtains a digital copy of the CD and makes available 160 digital services to the consumer concerning that CD. These services include (but are not limited to) streaming music from the CD to the consumer or providing a digital copy of the CD.

According to the method of an alternate embodiment of the present invention, the customer/user need not be bothered with taking the action of obtaining 120 special purpose software and sending 130 a digital signature to the service provider. When the purchaser buys a CD (on the Internet, from a store, or otherwise) 170, the seller of the CD provides 180 an electronic proof of purchase to the buyer and the seller also sends 190 a copy of the electronic proof of purchase directly to the service provider. The service provider then grants 150, 160 equivalent rights to the consumer as are granted in a method relying on a media signature.

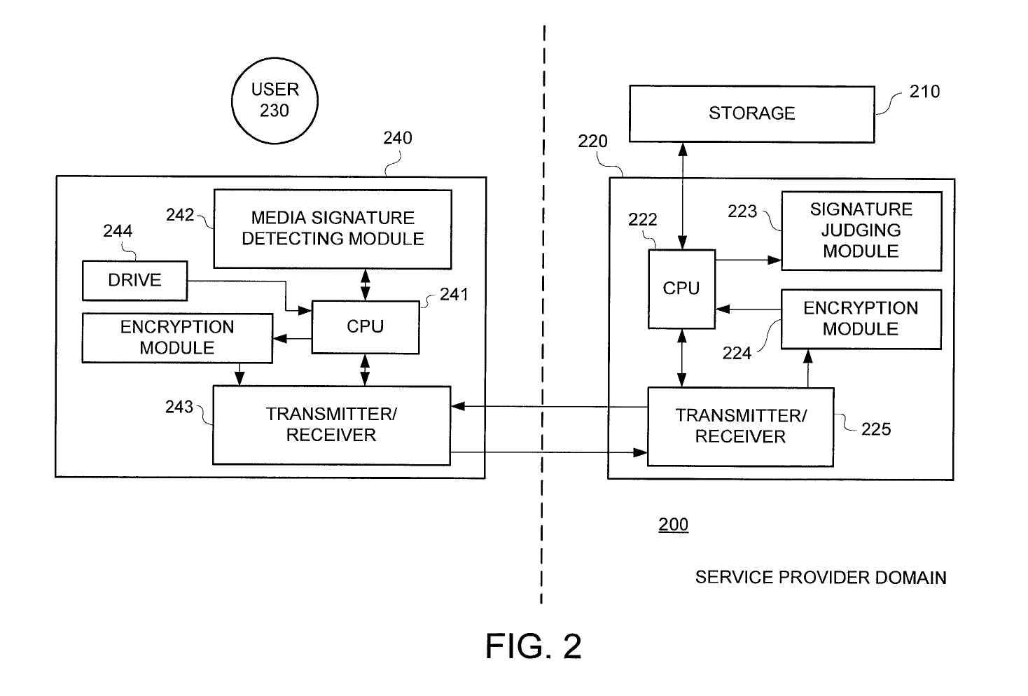

Referring to FIG. 2, the invention has a service provider domain 200, including a central media storage infrastructure 210 that contains a reservoir of audio data in electronic format, or optionally as a collection of physical media (e.g., audio CD's), for use by the service provider. The central media storage 210 is accessed by a general purpose computer 220, which includes a CPU 222, a signature judging module 223, an encryption module 224, and a transmitter/receiver 225.

A user 230 logs onto the service provider's website using a web access device 240 (for example, but not limited to, a personal PC) containing a CPU 241 which has a media signature detecting module 242, and a transmitter/receiver 243. The user logs into the service provider website via a sign-up process and is to upload a CD to be copied from a disk drive 244 via a transmitter/receiver 243 which is then encrypted with an encryption module 224.

If the CD has already been pre-positioned at the provider domain 200, the invention allows faster access time (as compared to the prior art) to digital services or copies from the service provider domain 200 (e.g., about 3 to 5 seconds as compared to 30 minutes with conventional methods). That is because the actual music on the CD is not being ripped, encoded, and uploaded, only the signature is being uploaded. The signature is then matched to items in the central media storage 210 by using the signature judging module 223 to see if the media title is already in the database.

Conventional methods require the user to copy, reformat, and transmit all of the content contained on the purchased entertainment media via tedious, lengthy uploads. The long upload time is costly in terms of system time. The present invention eliminates this long upload time by only requiring the transmission of the media signature and instructions as to which formats the user would like the service provider to provide.

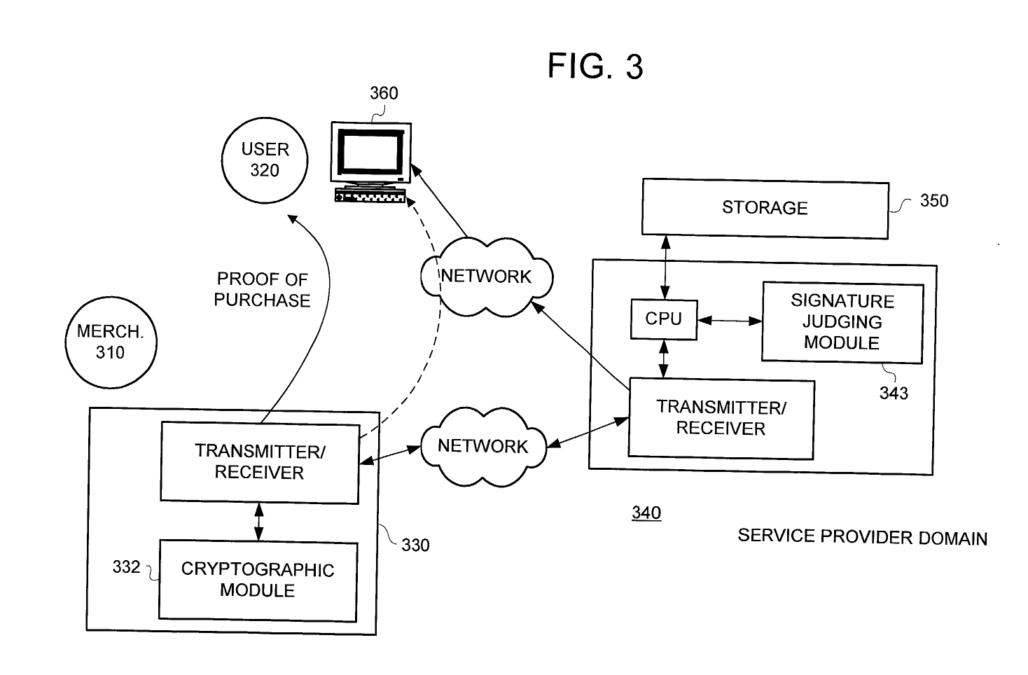

Referring to FIG. 3, a block diagram of a system according to another embodiment of the present invention is illustrated. This embodiment of the present invention eliminates the need for the customer/user to bother with obtaining special purpose software and sending a digital signature to the service provider. Rather, this is taken care of by the merchant 310 who sells the physical media to the customer 320, using a purchase validation apparatus 330. When the customer 320 buys a CD (on the Internet, from a store, or otherwise), the merchant's purchase validation apparatus 330 generates a unique electronic proof of purchase using a cryptographic module 332. This proof of purchase is provided to the buyer along with the CD, and the purchase validation apparatus 330 transmits a copy of the electronic proof of purchase directly to the service provider domain 340.

The service provider analyzes the proof of purchase using a signature judging module 343 to determine which particular CD title that particular consumer 320 has purchased. Upon approval of the transaction, the service provider ensures that a digital copy of the CD has been placed in its central media storage infrastructure 350 and makes the copy available to the consumer 320. The proof of purchase is matched to items in the central media storage 350 by using the signature judging module 343 to see if the media title is already in the database.

A user 320 logs onto the service provider's website using a web access device 360 (for example, but not limited to, a personal PC) that need not have a media signature detecting module. The user 320 is provided through their device 360 with digital electronic copies of the work they have purchased in the formats they specify. Formats that are commonly used at this time, such as MP3, RealAudio, and Windows Media Audio (WMA), are available, and there is no reason that future file formats cannot be used to implement the present invention. The various embodiments of the present invention are format independent and are not limited by the particular formats used to implement them.

In addition to faster replication speed, the invention also offers the user many other advantages. For example, the many safety features provide greater security and privacy than found in the conventional art.

As described above, methods and apparatus embodied according to the present invention offer unique feature that increase selection options and enhance the user's overall enjoyment of the music on the CD. The ability is provided for favorite songs to be linked together and mixed according to the user's tastes and preference. Users also benefit from on-site advertisements that inform them of other similar music that may be of interest and can be made available to them.

The invention obviates the need for the end customer to worry about fraud or copyright infringement and, according to certain embodiments, it protects vendors and copyright holders from losing sales through illegal and unauthorized copying of media.

The present invention has been described in terms of preferred embodiments, however, it will be appreciated that various modifications and improvements may be made to the described embodiments without departing from the scope of the invention.

What is claimed is:

1. A method of administering distribution of electronic digital copies of a literary work, the method comprising:
receiving from a user a digital signature having properties that correspond to one or more attributes of a physical object bearing a recording of the literary work;
revealing the one or more attributes of the physical object from the digital signature;
determining, based on the one or more attributes of the physical object, whether the user has physical possession of the physical object; and
selectively making accessible to the user electronic digital services concerning the literary work based on the determination of whether the user has physical possession of the physical object.

2. The method of administering distribution of electronic digital copies of a literary work of claim 1, wherein the electronic digital services comprise distributing an electronic digital copy.

3. The method of administering distribution of electronic digital copies of a literary work of claim 1, wherein the electronic digital services comprises providing streaming audio.

4. The method of administering distribution of electronic digital copies of a literary work of claim 1, wherein the one or more attributes of the physical object are revealed by performing a cryptographic transformation on the digital signature.

5. The method of administering distribution of electronic digital copies of a literary work of claim 1, wherein the one or more attributes of the physical object comprise errors.

6. The method of administering distribution of electronic digital copies of a literary work of claim 1, wherein the physical object is a CD and the one or more attributes of the physical object comprise the number of tracks on the CD and the length of each track.

7. The method of administering distribution of electronic digital copies of a literary work of claim 1, wherein the physical object is a CD and the one or more attributes of the physical object comprise extended track data.

8. The method of administering distribution of electronic digital copies of a literary work of claim 1, wherein the one or more attributes of the physical object comprise a serial number.

9. A computer system adapted to administer distribution of electronic digital copies of a literary work, the computer system comprising:
a processor; and
a memory electronically connected to the processor, the memory including software instructions adapted to enable the computer system to perform operations comprising:
receiving from a user a digital signature having properties that correspond to one or more attributes of a physical object bearing a recording of the literary work;
revealing the one or more attributes of the physical object from the digital signature;
determining, based on the one or more attributes of the physical object, whether the user has physical possession of the physical object; and
selectively making accessible to the user electronic digital services concerning the literary work based on the determination of whether the user has physical possession of the physical object.

10. The computer system of claim 9, wherein the electronic digital services comprise distributing an electronic digital copy.

11. The computer system of claim 9, wherein the electronic digital services comprises providing streaming audio.

12. The computer system of claim 9, wherein the one or more attributes of the physical object are revealed by performing a cryptographic transformation on the digital signature.

13. The computer system of claim 9, wherein the one or more attributes of the physical object comprise errors.

14. The computer system of claim 9, wherein the physical object is a CD and the one or more attributes of the physical object comprise the number of tracks on the CD and the length of each track.

15. The computer system of claim 9, wherein the physical object is a CD and the one or more attributes of the physical object comprise extended track data.

16. The computer system of claim 9, wherein the one or more attributes of the physical object comprise a serial number.

17. A method for granting electronic rights based on an electronic signature, the method comprising:
receiving an electronic signature transmitted via a network by a putative owner of a recording item;
analyze the electronic signature to determine the title of the recording item;
analyze the electronic signature to determine whether the recording item is unique to the putative owner; and
in the event the recording item is determined to be unique to the putative owner, granting rights to the putative owner as being true owner of the recording item, wherein the true owner is permitted access to digital electronic copies of works recorded on the recording item.

18. The method for granting electronic rights of claim 17, the method further comprising:
downloading to the true owner a digital electronic copy of works recorded on the recording item.

19. The method for granting electronic rights of claim 18, wherein the digital electronic copy is in MP3 format.

20. The method for granting electronic rights of claim 18, wherein the digital electronic copy is in WMA format.

21. The method for granting electronic rights of claim 18, wherein the digital electronic copy is in RealAudio format.

22. The method for granting electronic rights of claim 17, the method further comprising:
adding a copy of the works recorded on the recording item to a central data storage for downloading to true owners of legitimate copies of the recording item.

23. The method for granting electronic rights of claim 17, wherein the electronic signature is an electronic hash of information selectively extracted from the recording item.

24. The method for granting electronic rights of claim 17, wherein determining whether the recording item is unique to the putative owner is done based on attributes of the recording item.

25. The method for granting electronic rights of claim 24, wherein the attributes of the recording item on which the determination of uniqueness are based comprise errors.

26. A computer system adapted to grant electronic rights based on an electronic signature received over a network, the computer system comprising:
a processor; and
a memory electronically connected to the processor, the memory including software instructions adapted to enable the computer system to perform operations comprising:
receiving an electronic signature transmitted via the network by a putative owner of a recording item;
analyze the electronic signature to determine the title of the recording item;
analyze the electronic signature to determine whether the recording item is unique to the putative owner; and
in the event the recording item is determined to be unique to the putative owner, granting rights to the putative owner as being true owner of the recording item, wherein the true owner is permitted access to digital electronic copies of works recorded on the recording item.

27. The computer system of claim 26, wherein the software instructions included in the memory further enable the computer system to perform operations comprising:
downloading to the true owner a digital electronic copy of works recorded on the recording item.

28. The computer system of claim 27, wherein the digital electronic copy is in MP3 format.

29. The computer system of claim 27, wherein the digital electronic copy is in WMA format.

30. The computer system of claim 27, wherein the digital electronic copy is in RealAudio format.

31. The computer system of claim 26, wherein the software instructions included in the memory further enable the computer system to perform operations comprising:
adding a copy of the works recorded on the recording item to a central data storage for downloading to true owners of legitimate copies of the recording item.

32. The computer system of claim 26, wherein the electronic signature is an electronic hash of information selectively extracted from the recording item.

33. The computer system of claim 26, wherein determining whether the recording item is unique to the putative owner is done based on attributes of the recording item.

34. The computer system of claim 33, wherein the attributes of the recording item on which the determination of uniqueness are based comprise errors.

35. A system for granting electronic rights concerning a physical media bearing entertainment content, the system comprising:
a media signature detection module for reading and detecting a media signature on the physical media; and
a media signature judgment module for determining a specific title corresponding to entertainment borne on the physical media;
wherein electronic rights are granted to a person who owns the physical media, based on the determining a specific title corresponding to entertainment borne on the physical media.

36. The system of claim 35, wherein the media signature detection module is present on a user computer and the media signature judgment module is present on a service provider computer.

37. The system of claim 35, wherein the media signature detection module comprises a software application implemented on a computer.

38. The system of claim 35, wherein the media signature judgment module comprise a software application implemented on a computer.

39. The system of claim 35, wherein the media signature judgment module includes a comparator connected to make a comparison of a user provided signature to a signature from a media storage database.
